(19) United States
(12) Patent Application Publication
(10) Pub. No.: US 2008/0204791 A1
(43) Pub. Date: Aug. 28, 2008

(54) IMAGE-PROCESSING SYSTEM, IMAGE-PROCESSING LOG RECORDING METHOD, COMPUTER-READABLE MEDIUM, AND COMPUTER DATA SIGNAL

(75) Inventor: Minoru Yusa, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/834,770

(22) Filed: Aug. 7, 2007

(30) Foreign Application Priority Data
Feb. 28, 2007 (JP) 2007049039

(51) Int. Cl. G06F 3/12

(52) U.S. Cl. 358/1.15

(57) ABSTRACT

There is provided an image-processing system including a request acquisition unit that acquires an image processing request for an electronic document; an attribute information acquisition unit that acquires attribute information managed in connection with the electronic document by the document management system that manages the electronic document which is a target of the image processing request; a request-handling unit that causes a predetermined image-processing unit to perform image processing on the electronic document in accordance with the request; a log image generation unit that generates a log image of the electronic document in response to the request; a log information generation unit that generates log information based on the request or information obtained during the processing performed in the request-handling unit; and a log registration unit that registers into a predetermined log storage, the log image, the log information, and the attribute information acquired by the attribute information acquisition unit.

### CROSS-REFERENCE TO RELATED APPLICATIONS

This application is based on and claims priority under 35 USC 119 from Japanese patent Application No. 2007-049039 filed on Feb. 28, 2007.

### BACKGROUND

1. Technical Field

The present invention relates to an image-processing system, an image-processing log recording method, a computer-readable medium, and a computer data signal.

2. Related Art

Image-processing apparatuses, such as printers, copiers, scanners, facsimile machines, and multifunction machines that combine the functions of these image-processing apparatuses, have been widely used. Among the image-processing apparatuses, an image-processing apparatus that has the function of recording log information concerning executed processing, such as a processing type, an execution date and time, and an execution order of the executed processing has been conventionally known. Further, an image-processing apparatus having the function of additionally recording, together with the above-described log information, a log image that represents a resultant image generated through the executed processing has come along in recent years. The log image may be, for example, an image to be printed or a scanned image.

### SUMMARY

According to an aspect of the invention, there is provided an image-processing system including a request acquisition unit that acquires an image-processing request for an electronic document; an attribute information acquisition unit that acquires, from a document management system, attribute information managed in connection with the electronic document by the document management system that manages the electronic document which is a target of the image-processing request acquired by the request acquisition unit; an image-processing unit that performs image processing on the electronic document in accordance with the image-processing request; a log information generation unit that generates log information on the basis of the image-processing request acquired by the request acquisition unit or information obtained during the image-processing performed by the image-processing unit; and a log storage that stores, in connection with each other, a log image representing an image generated from the electronic document during the image processing by the image-processing unit, the log information generated by the log information generation unit, and the attribute information acquired by the attribute information acquisition unit.

### BRIEF DESCRIPTION OF THE DRAWINGS

Exemplary embodiments of the present invention will be described in detail based on the following figures, wherein:

FIG. 1 shows an example of a system configuration according to an exemplary embodiment;

FIG. 2 shows another example of the system configuration according to the exemplary embodiment;

FIG. 3 is a diagram for explaining an image-processing flow in a system according to the exemplary embodiment;

FIG. 4 is a diagram for explaining an image-processing flow in another system according to a modified example;

FIG. 5 is a diagram showing an example of information on background-image-adding conditions, and

FIG. 6 is a diagram showing an example of a hardware configuration in a computer.

### DETAILED DESCRIPTION

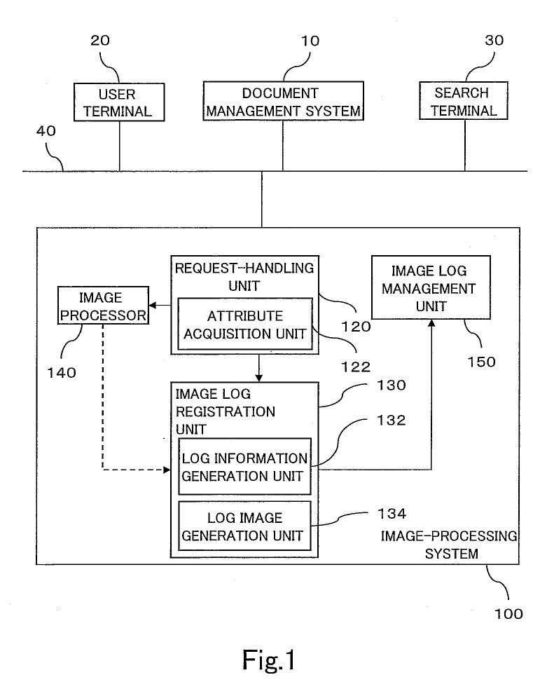

By reference to FIG. 1, a configuration example of a system according to an exemplary embodiment will be described. As shown in FIG. 1, the system according to the exemplary embodiment includes a document management system 10, a user terminal 20, a search terminal 30, and an image-processing system 100 interconnected via a network 40 such as a LAN (local area network) or the Internet for data communication.

The document management system 10 is a system for accumulating and managing electronic documents, each of which may be a file or an image file generated by an application. The document management system 10 accumulates the electronic documents or supplies an accumulated electronic document to the user terminal 20 in response to a request therefrom. In addition, the document management system 10 may provide a function of managing the status of the electronic documents according to workflow definition and other functions.

The document management system 10 stores, in connection with the electronic documents accumulated therein, attribute information of the electronic documents. Items contained in the attribute information of electronic documents are determined on the basis of a purpose or a particular use of the document management system 10. The attribute information may be incorporated into an electronic document file or may be managed as different data independent of the electronic document file.

For example, when the document management system 10 functions as a workflow system that manages passing of the electronic document between users to perform a business task, the attribute information of the electronic document may include an information item representing an approval stage. In a workflow registered in the document management system 10, one or more approval stages, such as a draft (unapproved) stage, a primary approval stage, a secondary approval stage, and a final approval stage, may be, in some cases, defined for the electronic document created in the workflow. Information denoting what approval stage the electronic document is in is an example of the attribute information item of the electronic document.

Still another example of the attribute information item of the electronic document is a document identifier used for uniquely identifying the electronic document in the system. Here, although the electronic document passed in one workflow changes its contents or attribute information, such as the approval status and other items, in response to processing performed in each workflow stage, the electronic document passed in such one workflow may be managed by means of a single common document identifier regardless of differences in the contents or the attribute information of the electronic document. The common document identifier assigned to the electronic document passed in such a workflow is another example of the attribute information item of the electronic document.

Further, information on a storage location of the electronic document in the document management system 10 is still another example of the attribute information item. The storage location of the electronic document is path information indicating a location of the electronic document in a directory (or folder) structure of the document management system 10. When a directory hierarchy is established using a metaphor for the actual world, such as a cabinet, a drawer, a folder, or a document, to perform management, information indicating what documents are contained in what folder, in what drawer, and in what cabinet is an example of the storage location information.

When the document management system 10 has the function of managing versions of the electronic document, version information is an example of the attribute information item of the electronic document. Still another example of the attribute information item is a file format of the electronic document, or file format information as to whether the electronic document is a file generated by an application or a file in an image file format (such as a bitmap format or a JPEG (Joint Photographic Experts Group) format), or the like.

The user terminal 20 is a terminal of a user who uses the document management system 10. The user accesses the document management system 10 from the user terminal 20 to register an electronic document into the document management system 10 or handle the electronic document stored in the document management system 10.

The search terminal 30 is a terminal used for searching for an image log (which will be described in detail below) record accumulated in an image-log management unit 150.

The user terminal 20 and the search terminal 30 may be configured, as hardware, with an ordinary computer, such as a personal computer or a workstation. The computer functions as the user terminal 20 or the search terminal 30 by executing or processing a program or data for use in an UI (user interface) provided to the user terminal 20 or the search terminal 30.

In response to instructions from the user who operates the user terminal 20, the image-processing system 100 performs image processing on the electronic document. The image processing performed by the image-processing system 100 may be processing accompanied with outputting of an image of the electronic document, such as printing or facsimile transmission of the electronic document. The electronic document which becomes a target of the image processing is provided from the document management system 10 or from the user terminal 20.

In the image-processing system 100, a request-handling unit 120 receives image processing request information for the electronic document from the document management system 10 or the user terminal 20, and causes an image processor 140 to perform image processing on the electronic document in accordance with the request information. For example, data referred to as print data or print job data are an example of the image processing request information. In the present exemplary embodiment, the attribute information of the electronic document managed by the document management system 10 is associated with the image processing request information and transmitted together. An attribute acquisition unit 122 extracts the attribute information. Alternatively, instead of transmitting the image processing request information and the attribute information of the electronic document in association with each other, when the request-handling unit 120 receives the request information, the attribute information of the electronic document may be retrieved from the document management system 10 by the attribute acquisition unit 122. In this case, so long as identification information of the electronic document is contained in the image processing request information, the attribute acquisition unit 122 can identify the electronic document using the identification information to obtain the attribute information.

The image processor 140 is an apparatus that performs an image processing function provided by the image-processing system 100. For example, when a printing function is provided as the image processing function, the image processor 140 may be a printer or a digital multifunction machine. On the other hand, when a facsimile transmission function is provided, the image processor 140 may be a facsimile machine or a digital multifunction machine.

An image log registration unit 130 creates an image log record regarding the image processing performed by the image processor 140 and registers the created image log record in the image log management unit 150. The image log record includes log information concerning the image processing performed by the image processor 140 and a log image that represents an image of the electronic document processed by the image processor 140. The log information may include items, such as an execution date and time of the image processing or identification information of a user who instructed the image processing.

A log information generation unit 132 generates the above-described log information on the basis of the image processing request information and information of log items supplied from the image processor 140 (such as, for example, an execution date and time of the processing). When the image processor 140 does not have the function of outputting the information of log items, the request-handling unit 120 may provide the information of log items such as the execution date and time, and the log information generation unit 132 may generate the log information on the basis of the information provided from the request-handling unit 120.

A log image generation unit 134 generates from an image of the electronic document created by the image processor 140 a log image that represents the created image. The log image may be the image of the electronic document itself created by the image processor 140, or may be one obtained by applying image processing such as data compression to the image of the electronic document. It is also conceivable that the image processor 140 does not have the function of supplying to the image log registration unit 130 data of the image of the electronic document created in the image processor 140. In this case, the log image generation unit 134 may generate the log image of the electronic document being a processing target on the basis of the image processing request information.

In the exemplary embodiment, the image log registration unit 130 registers the image log record including the log information generated by the log information generation unit 132, the log image generated by the log image generation unit 134, and the attribute information of the electronic document acquired by the attribute acquisition unit 122.

The image log management unit 150 accumulates the image log records registered by the image log registration unit 130 and provides the search terminal 30 with a search function of searching for the accumulated records. The image log management unit 150 receives, for example, search criteria in relation to a log information item from the search terminal 30, and supplies an image log record or a list of image log records containing the log information item that satisfies the search criteria. Here, the log information includes, in addition to items related to image processing, the attribute information items of the electronic document managed by the document management system 10. Accordingly, a criterion in relation to the log information items may be defined as the search criteria.

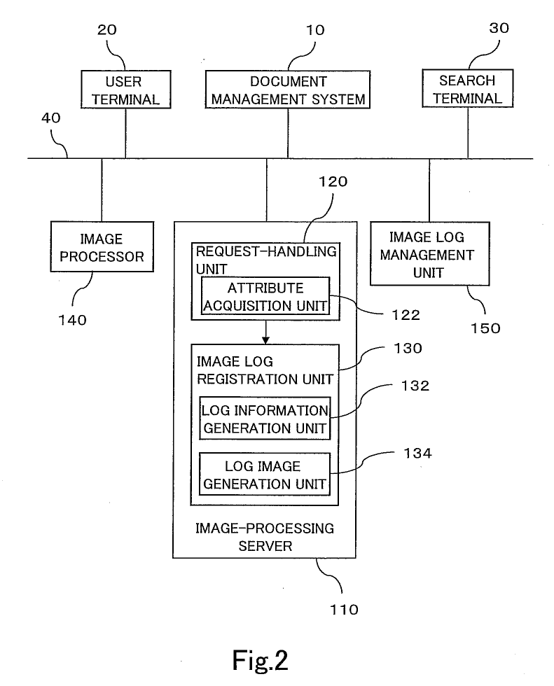

FIG. 1 shows an example of a functional configuration, but is not a diagram showing a specific hardware structure. For example, the image-processing system 100 may be, as shown in FIG. 2, composed of an image-processing server 110, the image processor 140, and the image log management unit 150 which are independent of one another and connected to the network 40. In this example, the image-processing server 110 has the functions of the request-handling unit 120 and the image log registration unit 130. For example, the image-processing server 110 may be a print server that accepts a print request. The image processor 140 and the image log management unit 150 respectively include their own computers connected to the network 40, and exchange instructions or data with the image-processing server 110 via the computers to implement their own functions. For example, upon receipt of image processing request information, the image-processing server 110 sends to the image processor 140, via the network, the received image processing request information or image processing instructions including image data generated from the received image processing request information. In addition, the image-processing server 110 generates an image log record and via the network registers the image log record into the image log management unit 150.

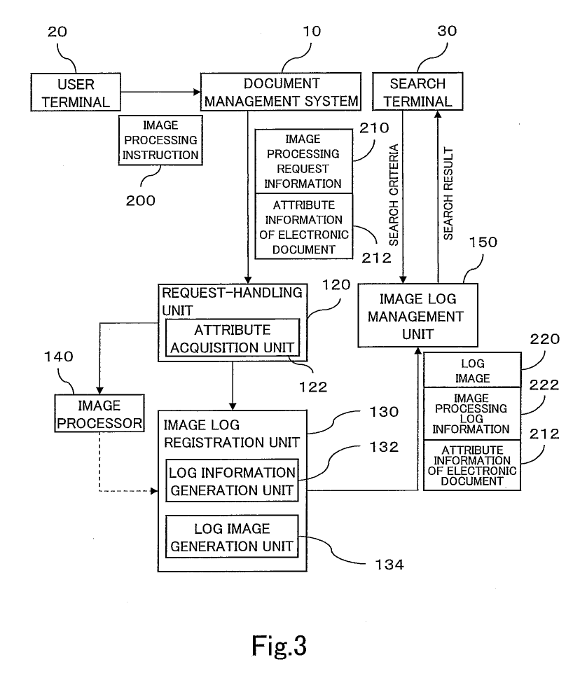

An operation example of the system according to the exemplary embodiment will be described by reference to FIG. 3. In this example, a user accesses the document management system 10 by operating the user terminal 20 to issue an instruction for image processing applied to an electronic document managed by the document management system 10. Here, the document management system 10 may, for example, display the directory structure in which the electronic document is stored or provide a function of conducting a search in which the attribute information is used as search criteria. Meanwhile, the user performs operation to instruct execution of the image processing applied to one or more electronic documents found on the display or located through the search function. In response to the user operation, an image-processing instruction 200 is transmitted from the user terminal 20 to the document management system 10. The image processing instruction 200 may contain information for specifying the electronic document and information for specifying or identifying the image processing to be applied to the electronic document. For example, the information for identifying the image processing may be a type of the image processing (such as printing or facsimile transmission), processing parameters (such as a paper size, the number of outputs, or a destination number) and the like.

The document management system 10 creates image processing request information 210 in accordance with the received image processing instruction 200. The image processing request information 210 includes image contents information that represents image contents in a target electronic document to be processed, and control information such as an image processing parameter. In a case of a print request, the image contents information may be described in page description language or the like, while the control information may be described in job description language or the like. The document management system 10 associates the created image processing request information 210 with the attribute information 212 of the target electronic document managed by the document management system 10 itself, and sends the image processing request information 210 together with the attribute information 212 to the image-processing system 100. It may be the case that the attribute information 212 to be sent to the image-processing system 100 includes only items to be recorded in the image log management unit 150 selected from among the attribute information items of the target electronic document managed by the document management system 10. The items to be recorded in the image log management unit 150 may be predefined in the document management system 10 or may be obtained through a query issued from the document management system 10 to the request-handling unit 120.

Upon receipt of the image processing request information 210 and the attribute information 212, the request-handling unit 120 in the image-processing system 100 causes the image processor 140 to perform image processing in accordance with the image processing request information 210. In this case, the request-handling unit 120 may pass the image processing request information 210 (such as, for example, print data) itself to the image processor 140, or may generate image data of the electronic document processable in the image processor 140 by processing the image processing request information 210, to thereby pass the generated image data to the image processor 140. Which of the image processing request information 210 or the generated image data is passed to the image processor 140 is determined depending on the function of the image processor 140. The image processor 140 performs the image processing (for example, printing or facsimile transmission) instructed by the request-handling unit 120.

While causing the image processor 140 to execute the image processing as described above, the request-handling unit 120 concurrently passes the image-processing request information 210 and the attribute information 212 to the image log registration unit 130. When the request-handling unit 120 has generated the image data of the electronic document, the generated image data may be additionally passed to the image log registration unit 130.

The log information generation unit 132 in the image log registration unit 130 generates information of each item in the log information regarding the image processing. The log information regarding the image processing may include, for example, information of predetermined items contained in the received image processing request information 210 (such as, for example, identification information of the user who has instructed the image processing or a specified paper size), the log information regarding the processing performed by either or both of the image processor 140 and the request-handling unit 120 (such as, for example, a processing date and time), and the like. Further, the log information generation unit 132 may generate, from the information representing the contents of the electronic document contained in the image processing request information 210, character string information used for a full-text search, and incorporate the generated character string information into the log information. The character string information can be used for the full-text search performed on the image log records stored in the image log management unit 150. In addition, the log image generation unit 134 generates a log image that represents an image of the electronic document generated by the image processor 140. When the image of the electronic document is provided from the image processor 140 or the request-handling unit 120, the log image may be generated from the provided image, or, when no image is provided, may be generated from the image processing request information 210.

The image log registration unit 130 registers in the image log management unit 150 the image log record containing the log image 220 generated by the log image generation unit 134, the log information 222 generated by the log information generation unit 132, and the attribute information 212 of the electronic document acquired by the attribute acquisition unit 122.

The image log management unit 150 provides the search terminal 30 with the search function using the log information or attribute information of the electronic document as search criteria. The search criteria may be a conditional expression relating to a value of a single item contained in the log information or the attribute information, or a combination of conditional expressions relating to multiple items. Further, the image log management unit 150 also provides a full-text searching function that searches for description of character strings contained in the log image of the image log record. Still further, the image log management unit 150 provides the search terminal 30 with the contents of the image log record; i.e. the log image 220, the log information 222, and the attribute information 212, retrieved as a result of search conducted using the above-described various search functions.

In this exemplary embodiment, as described above, the image log management unit 150 has the function of performing a search through the image log records accumulated in itself using the search criteria in relation to the attribute information of the electronic document managed by the document management system 10. The image log is, for example, when processing performed in the image processor 140 is printing or facsimile transmission, to retain a log of activities, such as a log as to which user has printed or performed facsimile transmission of what document under what situation, along with an image printed or a facsimile transmitted. Because paper documents are easily portable, a risk of occurrence of accidental information leakage may be incurred by printing an electronic document. Further, when illegal facsimile transmission is performed, the electronic document will be sent to an uncontrollable site, resulting in accidental information leakage. Contrarily, utilization of the image log can produce a deterrent effect of putting pressure on a user who attempts to illegally output a document. In addition, it is also conceivable that, in the event of a later information leakage accident, the image log may be used to track and find the user who has output the document or to track information of the leaked document itself.

Next, a specific application example of the system according to the exemplary embodiment will be described. A first example is described with respect to an instance where the document management system 10 is a workflow system for managing exchange of an electronic document between users to perform a business task. In the first example, it is assumed that the document management system 10 manages, as attribute information of the electronic document, approval stage information of the electronic document. For example, the approval stage information indicates an approval stage of the electronic document designated from among one or more approval stages. In this example, upon receipt of the image processing instruction 200 applied to an electronic document from the user terminal 20, the document management system 10 sends, as the attribute information 212, the approval stage information of the electronic document to the request-handling unit 120. The sent approval stage information is registered in connection with the log image 220 and the log information 222 into the image log management unit 150. For example, in an attempt to search for an image log record of a leaked document, whenever information regarding an approval stage is found from information on the leaked document, a searcher can specify search criteria including a condition in relation to the approval stage of the leaked document.

For example, in an instance where a document created through a workflow is released for common use, work procedures to release the document can be considered as follows. The document is firstly created, and subsequently edited to produce a final draft of the document. Then, after passing through primary and secondary approval, the document is released when a final approver grants approval. In the above-described flow, it is likely that operation of printing the document is performed in each approval stage to proofread the contents of the document. Thus, the document is modified through proofreading operation, creating multiple versions of the document having slightly different contents, and each version of the document is printed over the course of the workflow. As a result, a great number of image logs whose contents are quite similar will be accumulated. Accordingly, it is quite conceivable that a search for an image log can result in retrieval of a large amount of image logs including similar data even when, for example, the full-text search is conducted using a keyword, which causes a searcher difficulty in uniquely identifying the intended image log. On the other hand, when the approval stage information managed by the document management system 10 is incorporated into the image log record and stored together with the image log record, the approval stage can be used as a condition for identifying the image log record.

Further, another example will be studied with respect to an instance where the document management system 10 manages electronic documents handled through processing stages in a single workflow with a common document identifier regardless of the processing stages. In this instance, the document identifier is an item in the attribute information of the electronic documents. Here, it is assumed that the document management system 10 sends the document identifier along with the image processing request information 210 to the image-processing system 100, while the image log management unit 150 incorporates the document identifier into the image log record to store the identifier together with the image log record. Further, assuming a situation where a document created by use of a workflow system is designated as confidential upon final approval, a usage example of the document identifier will be described below.

After creating a document in the workflow system, a document author repeatedly edits and proofreads the document to bring a drafted version of the document to a complete version thereof, and passes the complete version of the document to a subsequent approval stage. Then, it is assumed that, after primary and secondary approval, the final approval is given to the document by a final approver. At this time, it may be adopted as a condition for the final approval that the number of disclosure destinations of the document is restricted to a small number of users and security designation as confidential is added. However, the document is likely to have been forwarded to several users who are not contained in the disclosure destinations and to have been printed many times by the users until the document reaches a stage of the final approval. Under such circumstances, there might arise a demand for tracking the users who have printed the electronic document before the final approval is granted to the electronic document. Thus, when the document identifier of the electronic document as described above is recorded in the image log record, the image log record regarding processing, such as printing, of the electronic document forwarded in one workflow can be found by a search using the document identifier as criteria irrespective of different stages of the processing, such as approval.

Further, in a case where after the electronic document of a drafted (unapproved) version, for example, is found to have been leaked, an image log record of the electronic document is identified through a search by means of a search key other than the document identifier, and the document identifier contained in the image log record can be obtained. Then, through another search performed in the document management system 10 using the obtained document identifier as the search key, the present status of the electronic document associated with the document identifier can be revealed. For example, there can be found information as to whether or not the final approval is given to the electronic document, or information as to whether or not the electronic document has the security designation as confidential. The found information may be used for evaluating, for example, influence exerted by leakage of the electronic document.

Meanwhile, when the document management system 10 retains attribute information, such as a storage location, version information, and a document format of each electronic document, the attribute information may be incorporated into the image log record. In this manner, search for an image log record can be conducted in the document management system 10 by using the attribute information of the electronic document as search criteria. In addition, upon retrieval of the image log record, the properties of the electronic document corresponding to the retrieved image log record can be easily identified from the attribute information contained in the image log record.

Next will be described an example modification in which the document management system 10 that manages the approval stage information of each electronic document attaches information to an image of the electronic document using the approval stage information. Here, a process for superimposing on an image of a target electronic document a background image corresponding to an approval stage of the target electronic document is exemplified. The background image is an image constituting a background of the electronic document, and is also referred to as a watermark image. Usage example of the background image is to superimpose a background image representing a character string or an image that denotes “confidential” or “handle with care” on an image of the electronic document. Various generation methods of such a background image have been already known, and any of the generation methods may be employed here. Also in this example, the image of the electronic document is further added with an image representing an identifier used for uniquely identifying the image of the electronic document. In the description below, a UUID (universally unique identifier) whose uniqueness is globally guaranteed is adopted as the identifier. However, the identifier is not limited to the UUID.

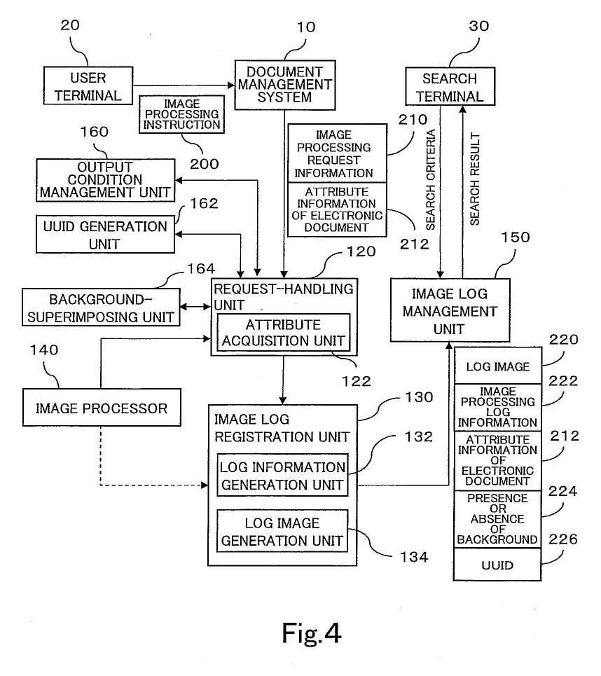

FIG. 4 shows a system configuration of the modified example. In the modified example of FIG. 4, the image-processing system 100 includes an output condition management unit 160, a UUID generation unit 162, and a background-superimposing unit 164. In FIG. 4, components corresponding to those shown in FIG. 3 are identified by reference numerals identical with those in FIG. 3.

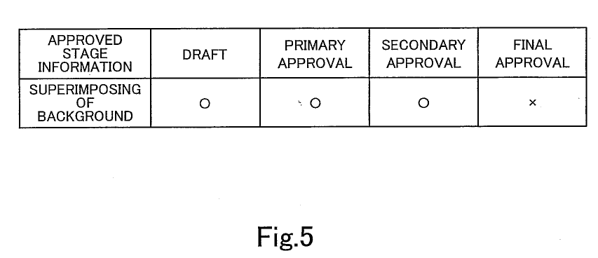

The output condition management unit 160 stores information on a requirement for adding a background image. FIG. 5 shows an example of contents of such requirement information retained in the output condition management unit 160. In this example, four approval stages of a draft, primary approval, secondary approval, and final approval are defined. A management table of the requirement information exemplarily shown in FIG. 5 defines for each stage whether or not a background image should be superimposed on an electronic document in that stage. Although the example of FIG. 5 denotes that documents in a final approval stage are not superimposed with the background image, whereas documents in stages other than the final approval stage are superimposed with the background image, the management table of requirement information is not limited to that shown in FIG. 5.

The UUID generation unit 162 generates a UUID to be assigned to the image of the target electronic document. The UUID is specified, for example, in RFC 4122 specifications or the like. The UUID generation unit 162 uses a known algorithm compliant with such a specification as described above to generate the UUID.

The background-superimposing unit 164 performs processing for superimposing a background image on an image of a target electronic document. Here, the background image may be a fixed image or may be changed so as to show contents corresponding to each approval stage. Although in this example the background-superimposing unit 164 superimposes a background image that represents both the approval stage and the UUID, another background image may be superimposed.

Next, a process flow in the modified example will be described. In this modified example, the document management system 10 associates the attribute information 212 including approval stage information of a target electronic document to be processed with the image processing request information 210 and sends to the request-handling unit 120 the image processing request information 210 with the attribute information 212. The request-handling unit 120 passes the approval stage information contained in the received attribute information 212 to the output condition management unit 160. The output condition management unit 160 references its own management table retained therein to find a value indicating whether or not to superimpose a background corresponding to a received value of the approval stage, and returns the found value to the request-handling unit 120. In addition, the request-handling unit 120 requests the UUID generation unit 162 to generate a UUID, and obtains the generated UUID.

Further, the request-handling unit 120 groups, as a set of information items, the image processing request information 210, the attribute information 212, the value indicating whether or not to superimpose a background received from the output condition management unit 160, and the UUID obtained from the UUID generation unit 162, and passes the set of information items to the image log registration unit 130. Upon receipt of the set of information items, the image log registration unit 130 generates the image processing log information 222 and the log image 220 and registers the generated image processing log information 222 and the log image 220 in connection with the attribute information 212, the information 224 indicating whether or not to superimpose a background, and the UUID 226. Such processing related to the image log may be performed in parallel with processing steps described below.

Still further, the request-handling unit 120 passes, to the background-superimposing unit 164, a set of information items including the image processing request information 210, the approval stage information contained in the attribute information 212, the value indicating whether or not to superimpose a background obtained from the output condition management unit 160, and the UUID obtained from the UUID generation unit 162.

The background-superimposing unit 164 determines whether or not a value in the item as to whether or not to superimpose a background contained in the received set of information items represents “superimposing of a background.” When “superimposing of a background” is determined, the background-superimposing unit 164 generates background image information that represents the approval stage and UUID contained in the received set of information items to incorporate the generated information into the image processing request information 210, and passes the image processing request information 210 with the generated information to the request-handling unit 120. The background image generated in this process is a combination of a specific character string or a specific image representing the approval stage (such as, for example, “draft” or “first approval”) and an image representing the UUID. The generation of the background image information or the incorporation of the background image information into the image processing request information 210 may be performed by means of publicly known techniques. On the other hand, when the value in the item as to whether or not to superimpose a background represents “superimposing of no background,” the background-superimposing unit 164 returns the received image processing request information 210 to the request-handling unit 120 without additionally processing the information 210.

The request-handling unit 120 causes the image processor 140 to perform image processing on the electronic document according to the received image processing request information 210 received from the background-superimposing unit 164. Here, when the background image information is incorporated in the received image processing request information 210, the image processor 140 superimposes the incorporated background image information on the image of the electronic document, and subsequently performs predetermined image processing (such as, for example, printing) on a resulting superimposed image.

A usage example of the system according to the modified example will be described below. During the course of the process in which the electronic document passes each approval stage in a workflow on the document management system 10, there is a possibility that confidential information temporarily appears in the text of the electronic document. Even though confidential information remains present in the text of a document upon completion of a final draft of the document, the confidential information can be deleted or rewritten through proofreading in following approval processes. It is, however, conceivable that an author of the document frequently prints the document; in particular, in a case where the document is a drafted version, in order to perform proofreading. In other words, it can be considered that there arises a situation in which the document which is likely to include confidential information is printed many times, to thereby output multiple versions of the document having slightly different contents. The printed outputs usually include image contents which are quite similar with each other. Accordingly, assuming that one of the printed outputs is leaked, it will become extremely difficult, owing to the similarity of the image contents, to locate the leaked one of the printed outputs only from the image contents even though the image logs are stored. Further, so long as the leaked one of the printed outputs is not identified, it is almost impossible to identify who is involved in the leakage. Thus, such inability of finding the one of the printed outputs will reduce the deterrent effect of the image log that prevents information leakage. This analysis on leakage adheres to a concept that leakage risk of a drafted version of a document is higher than that of a finally approved version of the document. The management table shown in FIG. 5 is based on this concept.

More specifically, when the management table of FIG. 5 is used in the modified example, the background image or the like is added to documents in stages prior to the final approval with the intention of exerting pressure on a person who prints the documents in order to deter information leakage. Further, the UUID information is added to the printed outputs of a document, to thereby ensure greater ease in uniquely identifying the document even when a large number of image logs of the document having similar contents are present. With the addition of the background image corresponding to a value of the approval stage, the approval stage can be easily identified from the printed output even in the unlikely event that no UUID can be read out from the printed output which is proof of leakage. So long as the approval stage is found, the image log records can be narrowed down to those in the found approval stage, to thereby facilitate the search.

Although the example of the management table shown in FIG. 5 is based on the concept that the leakage risk is higher in the stages prior to the final approval, this concept is presented only as one example. As another concept, a policy of stringently protecting the finally approved version among others may be adopted as in the case where security designation as confidential or as internal use only is given to the finally approved version. Such a policy may be implemented by changing the contents in the management table. In other words, the management table representing requirements for superimposing a background may be created so as to be pursuant to a document management policy of an organization that operates the image-processing system 100.

In the above, the exemplary embodiment and example modifications thereof have been described. Although, upon receipt of the instruction from the user terminal 20, the document management system 10 generates the image processing request information 210 and sends the generated image processing request information 210 to the image-processing system 100, such generation and sending processes are described only as an example. Alternatively, the user terminal 20 may generate the image processing request information 210 targeted at the electronic document registered in the document management system 10 and send the generated information 210 to the image-processing system 100. In this case, identification information of the electronic document used in the document management system 10 may be incorporated into the image processing request information 210, so that the image-processing system 100 can use the identification information contained in the image processing request information 210 to acquire the attribute information of the electronic document from the document management system 10.

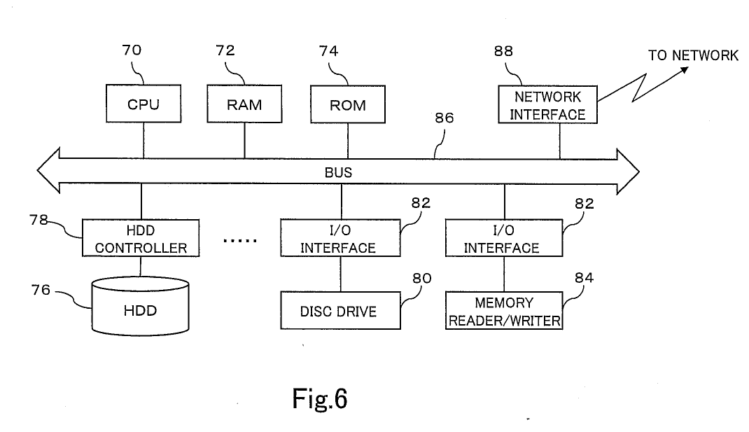

The above-described components in the image-processing system 100 other than the hardware components for performing image processing, such as printing or facsimile transmission, may be realized by means of a computer. To realize the component, programs in which the functions or processing details of the above-described components are described may be executed by the computer. Here, the computer may include as hardware, for example, a circuit configuration as shown in FIG. 6 in which a microprocessor, such as a CPU 70, memories (primary storages), such as a random access memory (RAM) 72 and a read only memory (ROM) 74, an HDD controller 78 for controlling an HDD (hard disc drive) 76, various I/O (input and output) interfaces 82, a network interface 88 for controlling connection with a network, such as a local area network, and other components are connected, for example, via a bus 86. In addition, via the I/O interfaces, for example, a disc drive 80 used for reading from and/or writing to a portable disc recording medium, such as a CD or a DVD, a memory reader/writer 84 for reading from and/or writing to a portable nonvolatile recording medium compliant with various standards, such as a flash memory, and other units may be connected to the bus 86. The program in which processing details according to the exemplary embodiment are described is stored via the recording medium, such as the CD or the DVD, or via communication unit, such as a network, in a fixed storage such as a hard disc drive, and installed into an image-forming apparatus or a computer. The program stored in the fixed storage is read out in the RAM 72 and executed by the microprocessor, such as the CPU 70, to thereby realize the processing operations described in the exemplary embodiment. The image-processing system 100 may be constructed on a single computer, or on multiple computers in a distributed manner. It should be noted that the image-processing system 100 may be partially or entirely configured by a hardware circuit such as, for example, an ASIC (application specific integrated circuit) or an FPGA (field programmable gate array). Similarly, the document management server 10, the user terminal 20, and the search terminal 30 may be implemented by means of a computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An image-processing system comprising:
a request acquisition unit that acquires an image processing request for an electronic document;
an attribute information acquisition unit that acquires, from a document management system, attribute information managed in connection with the electronic document by the document management system that manages the electronic document which is a target of the image processing request acquired by the request acquisition unit;
a request-handling unit that causes a predetermined image-processing unit to perform image processing on the electronic document in accordance with the image processing request;
a log image generation unit that generates a log image of the electronic document in response to the image processing request;
a log information generation unit that generates log information on the basis of the image processing request acquired by the request acquisition unit or information obtained during the processing performed in the request-handling unit; and
a log registration unit that registers into a predetermined log storage, in connection with each other, the log image generated by the log image generation unit, the log information generated by the log information generation unit, and the attribute information acquired by the attribute information acquisition unit.

2. The image-processing system according to claim 1, wherein the log image generation unit generates the log image on the basis of an image generated from the electronic document during the image processing by the image-processing unit.

3. The image-processing system according to claim 1, further comprising an output unit that outputs information stored in the log storage to an external device connected via a communication line.

4. The image-processing system according to claim 1, wherein the image-processing unit determines on the basis of the attribute information whether or not a background image is superimposed on an image of the electronic document, and, when superimposing of the background image is determined, superimposes the background image on the image of the electronic document to output the image of the electronic document with the superimposed background image.

5. The image-processing system according to claim 1, wherein the attribute information of the electronic document managed in the document management system is an approval status of the electronic document.

6. A method for recording a log regarding image processing, comprising:
acquiring an image processing request for an electronic document;
acquiring attribute information, from a document management system, attribute information managed in connection with the electronic document by the document management system that manages the electronic document which is a target of the acquired image processing request;
causing a predetermined image-processing unit to perform the image processing on the electronic document in accordance with the image processing request;
generating a log image of the electronic document in response to the image processing request;
generating log information on the basis of the image processing request or information obtained in the causing the predetermined image-processing unit to perform the image processing in accordance with the image processing request; and
registering, in connection with each other, the generated log image, the generated log information, and the acquired attribute information into a predetermined log storage.

7. A computer-readable medium storing a program causing a computer to execute a process for recording a log regarding image processing, the program causing the computer to function as:
a request acquisition unit that acquires an image processing request for an electronic document;
an attribute information acquisition unit that acquires, from a document management system, attribute information managed in connection with the electronic document by the document management system that manages the electronic document which is a target of the image processing request acquired by the request acquisition unit;
a request-handling unit that causes a predetermined image-processing unit to perform image processing on the electronic document in accordance with the image processing request;
a log image generation unit that generates a log image of the electronic document in response to the image processing request;
a log information generation unit that generates log information based on the image processing request acquired by the request acquisition unit or information obtained during the processing performed in the request-handling unit; and
a log registration unit that registers into a predetermined log storage, in connection with each other, the log image generated by the log image generation unit, the log information generated by the log information generation unit, and the attribute information acquired by the attribute information acquisition unit.

8. A computer data signal embodied in a carrier wave for enabling a computer to perform a process for recording a log regarding image processing, the process causing a computer to function as:
a request acquisition unit that acquires an image processing request for an electronic document;
an attribute information acquisition unit that acquires, from a document management system, attribute information managed in connection with the electronic document by the document management system that manages the electronic document which is a target of the image processing request acquired by the request acquisition unit;
a request-handling unit that causes a predetermined image-processing unit to perform image processing on the electronic document in accordance with the image processing request;
a log image generation unit that generates a log image of the electronic document in response to the image processing request;
a log information generation unit that generates log information based on the image processing request acquired by the request acquisition unit or information obtained during the processing performed in the request-handling unit; and
a log registration unit that registers into a predetermined log storage, in connection with each other, the log image generated by the log image generation unit, the log information generated by the log information generation unit, and the attribute information acquired by the attribute information acquisition unit.
